(19) United States
(12) Patent Application Publication
(10) Pub. No.: US 2007/0137788 A1
(43) Pub. Date: Jun. 21, 2007

(54) Method and system for position control of webs and corrugated board with a natural edge

(75) Inventors: Harald Loffler, Bielefeld (DE); Peter Sander, Graben (DE); Franz Guenter, Biberbach (DE)

Correspondence Address: FISH & RICHARDSON PC, P.O. BOX 1022, MINNEAPOLIS, MN, 55440-1022, US

(73) Assignee: TEXMAG GMBH VERTRIEBSGESELLSCHAFT GMBH, Thalwil (CH)

(21) Appl. No.: 11/300,888

(22) Filed: Dec. 15, 2005

(51) Int. Cl. B32B 37/00

(52) U.S. Cl. 156/324; 156/206; 156/378

(57) ABSTRACT

The invention relates to a method and a system for position control of one or more webs, particularly of paper-like or board-like webs, which are preferably used in manufacturing corrugated board and corrugated board which has a natural edge. For controlling the web position by means of position manipulation apparatuses, position information is used, which is detected downstream by position detection means.

### FIELD OF THE INVENTION

The invention relates to a method and system for position control of one or more webs, especially of paper-like or board-like webs, which are preferably used for the manufacture of corrugated board and corrugated board which has a natural edge.

### BACKGROUND

The principle construction of prior art installations for manufacturing corrugated board is shown in FIG. 1. Such an installation comprises one or more single-face groups, each of which joins together a flat and a corrugated web. Webs which are joined in such a way are called single-face webs. In the combination and lamination, the single-face webs and a cover web are joined together and laminated to a single web. After lamination, the web passes through the heat and pull area. Here, the web is dried by introducing heat. In the final processing, the web of corrugated board is trimmed at the edges and is, depending on the needs, further cut into desired formats and is transported into a store.

Manufacturing with known installations causes that the used material is not exploited in an optimal way because of inaccuracies of the manufacturing process.

### SUMMARY OF THE INVENTION

Accordingly, the present invention has the object to improve the manufacturing accuracy.

According to the invention, this object is achieved by a method, a system and a corrugated board according to the independent claims of the invention. Advantageous embodiments are described in the dependent claims.

According to the invention, a method for position control of one or more webs is provided, especially for paper-like or board-like webs. Here, the term web relates especially to paper or board webs, bit it can also relate among others to fabric webs, webs of plastic and webs of metal. A web can consist of one or more layers of one or of different materials. The method and the system of the invention can especially be adapted to such types of webs, which are used in the manufacturing of corrugated board. In this context, the term single-face web describes a web, which consists of two material layers, wherein one is flat and the other one is corrugated.

According to one aspect, the invention deals with optimizing the control of webs. Both for manufacturing a single-face web and for combining several single-face webs with a cover web, the most optimal position control is desirable. The better the positioning is when joining the webs together, especially relative to each other, the less scrap will be produced. For this purpose, the invention detects first position information for one or more webs downstream of one or more position manipulation apparatuses by first position detection means. Then, a control of the web position(s) is conducted by the position manipulation apparatus, using the first position information detected downstream.

Preferably, the position of one web is taken as a reference parameter for the control of the other webs, and a predetermined parameter gives the desired relative position of the other webs relative to the one web, respectively. The center of the web and/or one or both edges of the web can serve to determine the position of the web. In many installations, the center of the web serves to determine the position of the web, and the web position is aligned relatively to the center of the machines.

Furthermore, second position information for one or more webs can be detected in the region of the position manipulation apparatuses by second position detection means. This enables an even more accurate position control, because information is available for the location, where the control is acting, and for the location, which is to be manipulated by the control. Thus, the dynamics of the web can be taken into account for its position control.

Moreover, the second position information, especially its changes, can be used for controlling the position manipulation apparatuses of one or more of the other webs, especially to reduce the position displacement of the webs with respect to each other. This allows that not only one web is controlled to a desired position without taking the other webs into account, but that the webs are aligned to each other. This results in a number of advantages. This way, e.g. for one web, namely the reference web, the data acquired downstream does not need to be taken into account, a cheaper, even though most likely somehow more inaccurate control of the reference web can be realized. Furthermore, e.g. for lamination of several webs, the position of the webs relative to each other is of outstanding importance. In case that all webs are laminated in such a way that they are flush with each other on one side, this side does not need to be cut or trimmed later on, and material can be spared. Such a production, which can for the first time be implemented by the present invention, is called natural edge. For production, a manageable position fluctuation of all webs can be tolerated, as long as the webs do not fluctuate with respect to each other. In absence of a noteworthy relative fluctuation, it can be processed further with natural edge. Preferably, the second position information relates to the cover web, to which the positions of the one or more other webs are controlled.

The control can take the web speed and the distance into account, which the web to be controlled has to cover between the position manipulation apparatus and the position detection means. Thus, the dead time can be considered for the control, whereby the control can substantially be improved in its accuracy.

The detection of the first position information by first position detection means can be conducted in the region of the lamination, but after a bridge, and especially in the region of the pre-heater or the glue unit, or directly in front of the lamination. Namely, the position detection is conducted behind the bridge, on which the position manipulation means are arranged. Position information is detected only for one or more webs, depending on the needs. The same holds for the control of the one or more position manipulation apparatuses. A web can either or alternatively be controlled by the information extracted downstream about itself or the information extracted from one or more other webs.

Alternatively, the detection can be conducted for the first position information by first position detection means in the region of the pre-heater, and the detection can be conducted for the third position information by third position detection means in the region of the glue unit. Hereby, information is available about at least two positions of one or more webs, so that the dynamics of the system can better be taken into account. Accordingly, the first position information as well as the third position information can be used for controlling the position manipulation apparatuses.

The position manipulation apparatuses are arranged upstream of the region of the pre-heater, particularly they are arranged on the bridge.

Alternatively or additionally, the first position detection means are arranged in the region of the combination of two material layers, particularly in the region of a corrugated roller. The one or more position manipulation means are then preferably arranged upstream of a material layer heater and/or a material layer humidifier.

By controlling a material layer depending on the first position information, the position of both material layers with respect to each other can be optimized, particularly that they are centered on top of each other or that the edges of one side are on top of each other. This is in turn of importance for working with the natural edge.

Preferably, the control of the web positions controls the position manipulation apparatuses such that the web positions are flush with each other on one side, particularly so that this side does not need to be trimmed anymore.

Optical sensors, cameras, CCD cameras, ultrasonic devices or piezoelectric elements working with ultrasound can be used for the position detection means. Particularly, the invention is used for installations for corrugated board production, e.g. for corrugated board installations with one to five single-face groups.

According to a second aspect of the invention, the web width of at least one web is measured at a plurality of positions in the course of the corrugated board manufacturing. Depending on the respective measurement arrangement for measuring the web width, a position detection means or a separate width measurement apparatus can be used. Alternatively or additionally to measuring the width, the moisture of the web can be measured. The acquired information concerning width and moisture serves e.g. to determine a shrink factor, i.e. the relationship between one width and another, for a certain manufacturing segment or for the whole process. This information can be used for controlling the humidification to achieve a better process stability. Furthermore, the acquired shrink factors can serve for judging the quality of the used raw materials.

A first web width and/or a first web moisture is preferably measured after unwinding of a supply roller. At this point, the material still has its original width and moisture, it has not yet been humidified or joined with another web. Therefore, the value determined here is used as a reference value for determining an overall shrink factor. Since it can be measured at such a position for each supply roller, it is advantageous to use the average value of the widths and moistures measured this way.

Furthermore, after producing a single-face corrugated board, a second web width and/or a second web moisture can be measured, and particularly the first web widths and the second web widths can be used to judge the accuracy of the join.

Additionally, before of lamination and/or directly after lamination in front of the heat and pull area and/or in front of the first trimming of the web, a web width and/or web moisture can be measured. Such attained sector-wise factors can be used for controlling the respective single processes, such as humidification, drying or heating. Measurements in front of the first trimming in combination with measurements after unwinding can be used to calculate factors for the whole process, e.g. the shrink factor of the whole installation.

Moreover, the web widths in front of lamination and the web width in front of the first trimming of the web are used to judge the accuracy of the combination and/or the overlap.

A further aspect of the invention relates to a combination and lamination of a corrugated board installation, which comprises a system according to the invention as described above. The installation for producing corrugated board can additionally comprise one or more single-face groups and/or a heat and pull area and/or a final processing.

The principles of the present invention can not only be used for position control, but they can be used for web tension control in an analogous way. All aspects which are disclosed for position control in this description or in the claims can be transferred and used for web tension control.

For web tension control the position detection means are replaced, particularly by tension sensing rollers, or adapted so that they are able to detect a web tension. The position manipulation apparatuses are replaced or adapted so that they are able to manipulate a web tension.

Both for manufacturing a single-face web and for combining several single-face webs with a cover web, the most optimal web tension control is desirable. For this purpose, the invention detects first web tension information for one or more webs downstream of one or more web tension manipulation apparatuses by first web tension detection means. Then, a control of the web tension(s) is conducted by the web tension manipulation apparatus, using the first web tension information detected downstream.

### SHORT DESCRIPTION OF THE DRAWINGS

Further aspects and advantages of the present invention will become clear from the detailed description of the attached drawings.

FIG. 1 is a schematic overview of an installation for producing corrugated board.

FIG. 2 is a schematic view of a single-face group of an installation for producing corrugated board according to the present invention;

FIG. 3 is a schematic view of a combination, lamination and a heat and pull area according to the present invention; and

FIG. 4 is a schematic view of a final processing according to the present invention.

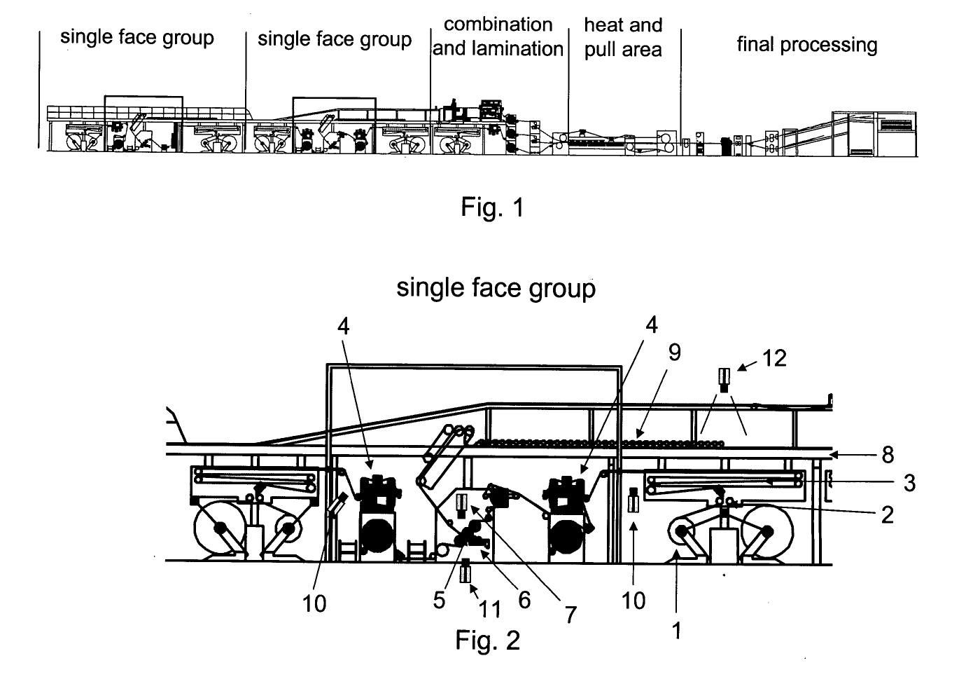

### DETAILED DESCRIPTION

FIG. 2 is a schematic view of a single-face group. There can be one or more of such single-face groups in an installation for producing corrugated board.

In terms of their function and their principle construction, they are all the alike. The paper or paper-like raw material is on a supply roller 1. The supply rollers 1 are always arranged in pairs, wherein the material is unwound from one roller, whereas the other roller is kept ready for replacement. If the material of one roller is exhausted, it will be spliced at position 2 to the other roller, so that the material supply does not break away. From here, the paper is passed to a first material storage 3. Paper is stored here to compensate for the delay of paper supply, when splicing from one roll to another. To regulate the storage content of storage 3, the pulleys on the right and left side of the storage can be moved towards each other or separated from each other.

From the first storage 3, the paper is guided to a position manipulation apparatus 4 and passes on it's way a width and/or moisture detection means 10. The width and/or moisture detection means 10 detects the values of the paper web in its original state. Behind the position manipulation means 4, the paper is guided via rollers, where it is heated particularly with rollers, which are supplied with hot steam from the inside. Additionally, the paper is humidified on its way to improve its ductility and to facilitate a joining of two paper layers later on.

The web coming from one side is then guided over a corrugated roller 5, where it is forced into a corrugated form. A glue apparatus 6 applies glue to this web. From the other side comes a second web, which is then glued together with the corrugated web with a single-face web. In the region of gluing both webs together, a position detection means 7 as well as a width and/or moisture detection means 11 is arranged. The position detection means 7 detects the position of both webs and/or their relative position to each other. This information can be used in different ways for controlling the position manipulation apparatuses 4. It can, for example, be used to control one or both webs to an accurate position at the combination or to control one web such that it is accurately aligned to the other web. Preferably, one web is controlled to a predetermined position, wherein the other web is aligned with respect to the first web. For working with the natural edge, i.e. one side does not need to be cut or trimmed, the webs are controlled such that the edges of both webs lie accurately on top of each other on one side.

For moisture control, the width and/or moisture detection means 11 is arranged in the region of the corrugated roller 5. Thereby, the humidification of the respective webs can be controlled, so that there are constant and controlled conditions for lamination.

The produced single-face web is transported onto the bridge 8. Here, a second storage, the so-called bridge storage 9, is arranged. It serves as a provision for the further processing. Normally, the production of the single-face web is slowed down when splicing from one supply roller 1 to another supply roller to allow for a save and therefore slower splicing. For this time interval, the bridge storage 9 serves as a provision to allow that the manufacturing process can continue with a speed of about 100 to 400 meters per minute. After having changed to a new supply roller 1, the production speed of the single-face web is raised to a value above average in order to refill the bridge storage 9.

A position detection means and/or a width and/or moisture detection means 12 is arranged at the end of the bridge storage 9. Further data for process control and optimization is attained here. Particularly, information about the bridge storage can be attained here at the same time.

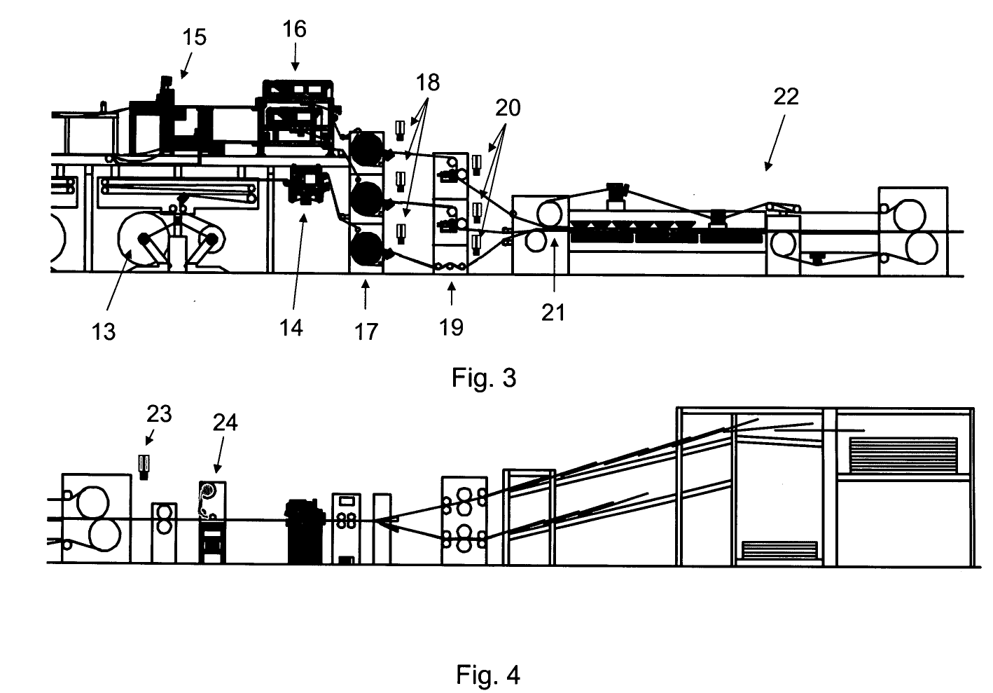

FIG. 3 shows a schematic view of a combination, a lamination and a heat and pull area. The one or more single-face webs are guided hither. The position manipulation apparatuses 15, 16 control a position of the single face webs as well as the needed web tensions. From a cover layer supply roller 13, the cover layer is guided via a storage to position manipulation apparatus 14. A width and/or moisture detection means can in turn be arranged in front of the position manipulating apparatus 14 in order to also detect the width of the cover web or its moisture.

Behind the position manipulation apparatuses 14, 15, 16, the webs are guided via a pre-heater 17 and a glue unit 19 to the lamination 21, where the webs are joined together. Here, a positioning of the webs with respect to each other as accurate as possible is desirable. Only if the webs are glued together being flush on one side, it can be operated with the natural edge. Alternatively, all webs can be aligned centered to each other. However, it is decisive that the position of the webs at the point of lamination is of highest importance, whereby the last position manipulation apparatuses 14, 15, 16 are even placed in front of the pre-heater 17. Those cannot be placed closer to the lamination because of constructional reasons. Thus, the last position control possibility is quite a bit away from the lamination 21. For this reason, the invention provides position detection means 18, 20, by which information concerning the web positions can be attained at places, which are substantially closer to the decisive lamination. Only single position detection means 18, 20 can be assembled depending on the needs. For example, it can only be measured after the glue unit 19, and also not all webs need to be measured. The information attained by the position detection means 18, 20 are used for controlling the position manipulation apparatuses 14, 15, 16.

Here, again different types of information usage are possible. Each web can be viewed separately and controlled to a certain position, whereby the deviation from this value, which is measured by the position detection means 18, 20 is used as a reference value for controlling the position manipulation apparatuses 14, 15, 16.

Alternatively, a web, particularly the cover web, can serve as a reference. Then, the positions of the other webs are controlled with respect to this one. Additionally, the information attained for the reference web can be used to control the other webs for tracking them or to compensate for the dynamics of the reference web.

Taking the dynamics into account is particularly possible, when measuring in the region of the pre-heater 17 and in the region of the glue unit 19 at the same time.

Furthermore, the position manipulation apparatuses 4, 14, 15, 16 themselves can be equipped with position detection means.

When using the information attained from the position detection apparatuses 18, 20, the distance, which has to be covered by the web between the position manipulation apparatuses 4, 14, 15, 16 and the measurement location as well as the web speed are taken into account. Additionally to the dead time, attenuations can be set.

Width and/or moisture detection means can be used additionally or alternatively to the position detection apparatuses 18, 20. Thereby, the desired moisture of the webs at the lamination 21 can be guaranteed. Additionally, all widths can be measured in front of the lamination 21.

After the lamination 21, the web is dried within the heat and pull area. Circulating strips pull the web through this area, whereby the web is guided next to heating elements. The board is dehumidified and dried by introducing heat.

FIG. 4 is a schematic view of a final processing. After the heat and pull area 22, another width and/or moisture detection means 23 is arranged. The measured moisture serves to control the amount of heat to be introduced within the heat and pull area 22. The width measured is used together with the width value measured after unwinding to calculate a shrink factor of the whole manufacturing process. It gives a picture of the quality of the used raw materials. Additionally, the value measured here can be used to judge the positioning at the lamination 21 and to improve it if needed. That way, the board web should not be much broader at the measurement position after the heat and pull area 22 than the single webs in front of the lamination 21. Furthermore, the shrink factor of the heat and pull area 22 can be attained.

The web is forwarded to the first trimming 24. Usually, the edges of the web are cut or trimmed here. The invention makes operation with the natural edge possible. In this case, the corrugated board needs only to be trimmed on one side. However, the inventive system does not need to be operated with the natural edge. In the further course, the web is cut in two desired dimensions in longitudinal and transversal directions, and it is transported into a storage, which is schematically shown on the right side of FIG. 4.

1. Method for position control of one or more webs, which comprises the following steps:
detection of first position information for one or more webs downstream of one or more position manipulation apparatuses by a first position detection means;
controlling the web position(s) by the position manipulation apparatuses using the first position information detected downstream.

2. Method for position control according to claim 1, wherein the position of a web is used as a reference value for controlling the other webs, and a respective predetermined parameter gives a desired relative position of a respective other web.

3. Method for position control according to claim 1, wherein the web center and/or one or both web edges are used for determining the web position.

4. Method for position control according to claim 1, wherein further second position information for one or more webs in the region of the position manipulation apparatuses is detected by a second position detection means.

5. Method for position control according to claim 4, wherein the second position information, is used for controlling the position manipulation apparatuses of one or more of the other webs to reduce displacement of the webs with respect to each other.

6. Method for position control according to claim 5, wherein the second position information is related to the cover web to which the positions of the one or more other webs are controlled.

7. Method for position control according to claim 1, wherein the controlling takes into account the web speed and the distance, which the web to be controlled has to cover between the position manipulation apparatus and the first position detection means.

8. Method for position control according to claim 1, wherein the detection of the first position information by the first position detection means is done in the region of a lamination, but after a bridge.

9. Method for position control according to claim 1, wherein the detection of the first position information by the first position detection means is done in the region of a pre-heater, and the detection of third position information by a third position detection means is done in the region of a glue unit.

10. Method for position control according to claim 9, wherein the first position information as well as the third position information is used to control the position manipulation apparatuses.

11. Method for position control according to claim 1, wherein the position manipulation apparatuses are arranged upstream of the region of a pre-heater.

12. Method for position control according to claim 1, wherein the first position detection means is arranged in the region of the combination of two material layers.

13. Method for position control according to claim 1, wherein the position manipulation means is arranged upstream of a material layer heater and/or a material layer humidification.

14. Method for position control according to claim 1, wherein, by controlling one material layer depending on the first position information, the position of two material layers with respect to each other is optimized, so that they are lying centered over each other or that the edges of side lie on top of each other.

15. Method for position control according to claim 1, wherein the step of controlling the web position controls the position manipulation apparatuses, so that the web positions are flush with each other on one side.

16. Method for position control according to claim 1, wherein at least one optical sensor, at least one camera, at least one CCD camera, at least one ultrasonic device or at least one piezoelectric element using ultrasound is used as the first position detection means.

17. Method for position control according to claim 1, wherein the method is employed within an installation for corrugated board manufacturing.

18. Method for position control according to claim 1, wherein a plurality web widths of at least one web are measured at a plurality of positions in the course of the corrugated board manufacturing.

19. Method for position control according to claim 18, wherein a first web width and/or a first web moisture is measured after unwinding from a supply roller.

20. Method for position control according to claim 19, wherein, after the production of a single-face corrugated board, a second web width and/or a second web moisture is measured, and the first web width and the second web width are used to judge the accuracy of joining.

21. Method for position control according to claim 19, wherein a second web width and/or a second web moisture is measured in front of a lamination and/or directly after a lamination in front of a heat and pull area and/or in front of a first trimming of the web.

22. Method for position control according to claim 21, wherein a shrink factor is determined from the second web width and/or the second web moisture in front of the first trimming of the web and the first web width and/or the first web moisture.

23. Method for position control according to claim 21, wherein a web width in front of the lamination and a web width in front of the first trimming of the web are used to judge the accuracy of the joining and/or the alignment.

24. Corrugated board, which is produced by using the methods according to claim 1.

25. Corrugated board which has a natural edge.

26. System for position control of one or more webs, which comprises at least one position manipulation apparatus and a first position detection means, which are arranged downstream of the position manipulation apparatus, wherein at least one position manipulation apparatus is adapted to take into account position information data attained downstream by the first position detection means.

27. System for position control according to claim 26, wherein the system is adapted, so that the position of a web is used as a reference value for controlling the other webs, and a respective predetermined parameter gives a desired relative position of a respective other web.

28. System for position control according to claim 26, wherein the system is adapted, so that the web center and/or one or both web edges are used for determining the web position.

29. System for position control according to claim 26, wherein the system is adapted, so that second position information for one or more webs in the region of the position manipulation apparatus is detected by a second position detection means.

30. System for position control according to claim 29, wherein the system is adapted, so that the second position information, is used for controlling the position manipulation apparatuses of one or more of the other webs to reduce displacement of the webs with respect to each other.

31. System for position control according to claim 30, wherein the system is adapted, so that the second position information is related to the cover web to which the positions of the one or more other webs are controlled.

32. System for position control according to claim 26, wherein the system is adapted, so that the position manipulation apparatus takes into account the web speed and the distance, which the web to be controlled has to cover between the position manipulation apparatus and the first position detection means.

33. System for position control according to claim 26, wherein the system is adapted, so that the detection of the first position information by the first position detection means is done in the region of a lamination, but after a bridge.

34. System for position control according to claim 26, wherein the system is adapted, so that the detection of the first position information by the first position detection means is done in the region of a pre-heater, and the detection of third position information by a third position detection means is done in the region of a glue unit.

35. System for position control according to claim 34, wherein the system is adapted, so that the first position information as well as the third position information is used to control position manipulation apparatuses.

36. System for position control according to claim 26, wherein the system is adapted, so that the position manipulation apparatuses are arranged upstream of the region of a pre-heater.

37. System for position control according to claim 26, wherein the system is adapted, so that the first position detection means is arranged in the region of the combination of two material layers.

38. System for position control according to claim 26, wherein the system is adapted, so that the position manipulation means is arranged upstream of a material layer heater and/or a material layer humidification.

39. System for position control according to claim 26, wherein the system is adapted, so that by controlling one material layer depending on the first position information, the position of two material layers with respect to each other is optimized, so that they are lying centered over each other or that the edges of one side lie on top of each other.

40. System for position control according to claim 26, wherein the system is adapted, so that the web positions are flush with each other on one side.

41. System for position control according to claim 26, wherein the system is adapted, so that at least one optical sensor, at least one camera, at least one CCD camera, at least one ultrasonic device or at least one piezoelectric element using ultrasound is used as the first position detection means.

42. System for position control according to claim 26, wherein the system is adapted, so that the system can be used within installations for corrugated board manufacturing.

43. System for position control according to claim 26, wherein the system is adapted, so that a first web width and/or a first web moisture is measured in front of a lamination and/or directly after a lamination in front of a heat and pull area and/or in front of a first trimming of the web.

44. System for position control according to claim 43, wherein the system is adapted, so that the first web width and/or a first web moisture is measured after unwinding from a supply roller.

45. System for position control according to claim 44, wherein the system is adapted so that, after the production of a single-face corrugated board, a second web width and/or a second web moisture is measured, and the first web width and the second web width are used to judge the accuracy of joining.

46. System for position control according to claim 43, wherein the system is adapted, so that a second web width and/or a second web moisture is measured in front of the lamination and/or directly after the lamination in front of the heat and pull area and/or in front of the first trimming of the web.

47. System for position control according to claim 46, wherein the system is adapted, so that further a shrink factor is determined from the second web width and/or the second web moistures in front of the first trimming of the web and the first web width and/or the first web moistures.

48. System for position control according to claim 46, wherein the system is adapted, so that a web width in front of the lamination and a web width in front of the first trimming of the web are used to judge the accuracy of the joining and/or the alignment.

49. Installation for production of corrugated board, wherein a combination and lamination comprises a system according to claim 26.

50. Installation for production of corrugated board according to claim 49, further comprising one or more single-face groups and/or a heat and pull area and/or a final processing.
